(19) United States
(12) Patent Application Publication
(10) Pub. No.: US 2026/0036154 A1
(43) Pub. Date: Feb. 5, 2026

(54) TELESCOPIC POLE SEGMENT COUPLER FOR FORESTRY, ARBORIST AND HORTICULTURE

(71) Applicant: Barnel International, Inc., Portland, OR (US)

(72) Inventors: Linn E. Nelson, Portland, OR (US); Karl H. Zeller, Portland, OR (US)

(73) Assignee: Barnel International, Inc., Portland, OR (US)

(21) Appl. No.: 19/282,961

(22) Filed: Jul. 28, 2025

Related U.S. Application Data
(60) Provisional application No. 63/678,670, filed on Aug. 2, 2024.

(51) Int. Cl. F16B 7/14; F16B 7/04

(52) U.S. Cl. CPC F16B 7/1418; F16B 7/042

(57) ABSTRACT

A coupler for telescopic pole segments has low profile locking mechanism actuators for providing a double locking function that reduces engagement with branches.

### CROSS REFERENCE TO RELATED APPLICATIONS

This application claims benefit of US provisional patent application Ser. No. 63/678,670 filed Aug. 2, 2024, which is incorporated herein by reference.

### BACKGROUND

This disclosure relates to forestry, arborist and horticulture, and more particularly to a coupler mechanism for enabling extension, retraction and locking of an extensible pole adapted for mounting forestry or horticultural tools thereto for long reach.

Extensible or telescopic poles are helpful for use in forestry, arborist and horticulture to allow a user to employ tools much higher than a person's natural reach. Such use might be, for example, to remove or prune tree branches or remove palm fans. For such uses, extensible poles are available that can mount tools, such as a saw or pruner, for example, to allow the saw or pruner to extend up to a great height. A coupling mechanism is employed to allow pole segments to be extended or retracted and secured at a desired extension/retraction position and allows multi extension to reach greater heights.

An example of such pole mechanism 10 is in FIGS. 1-2, where multiple pole segments nest together, allowing sections to extend to increase the overall length of the pole. In the particular example, the pole segments have regularly spaced holes therein, and a coupling mechanism on each segment has a retractable pin that may enter a particular hole, securing the pole segment in the extended position.

A first pole segment 12 receives a second pole segment 14 in the interior thereof, engaged to allow translational movement of the 2 pole segments relative to each other in the direction of arrow 16, allowing extension and retraction of the overall pole length. Pole 14 is slightly lesser diameter than pole 12, which allows movement between the 2 poles.

Mounted at the end of pole 12, is lock/clamp mechanism 18 which has a pin operation mechanism 20 comprising a lever that extends a pin into one of the holes in the pole segments when in the position of FIG. 1, locking the 2 pole segments against extension or retraction along the directions of arrow 16, or, when the lever is depressed in the direction of arc 22, withdraws the pin from the holes in the 2 poles, allowing movement of the poles relative to each other.

An additional locking mechanism is provided in form of a clamping/tightening mechanism knob 24, which clamps against the upper pole 14 when tightened, to provide additional prevention of unintended movement of the poles relative to each other, if the mechanism 20 is inadvertently actuated.

Referring to FIG. 2, a top view of the coupler of FIG. 1, it will be understood that the clamping/tightening mechanism 24 is a threaded member that upon tightening, will cause the upper portions of the coupler to clamp against the upper pole, to lock it in position.

It can be observed that the lever mechanism 20 and tightening mechanism 24 extend outwardly from the general periphery of the clamp mechanism. As such, when working in situations such as a tree with many branches, it is possible for the mechanism 20 and 24 may snag on branches which might be inconvenient for the user.

### SUMMARY

In accordance with the disclosure, an improved telescopic pole utilizes low profile locking mechanisms that are less likely to tangle with tree branches and the like.

The subject matter of the present technology is particularly pointed out and distinctly claimed in the concluding portion of this specification. However, both the organization and method of operation, together with further advantages and embodiments thereof, may best be understood by reference to the following description taken in connection with accompanying drawings wherein like reference characters refer to like elements.

### BRIEF DESCRIPTION OF THE DRAWINGS

FIG. 1 is a perspective view of pole segment coupler in accordance with the prior art;

FIG. 2 is a top view of the coupler of FIG. 1;

FIG. 3 is a perspective view of 2 segments of a telescopic pole coupler mechanism in accordance with the disclosure;

FIG. 4 is a top view of the coupler mechanism;

FIG. 5 is a bottom view of the coupler mechanism;

FIG. 6 is a sectional view taken along line 6-6 of FIG. 3; and

FIG. 7 is a perspective view of an alternative configuration pole segment coupler.

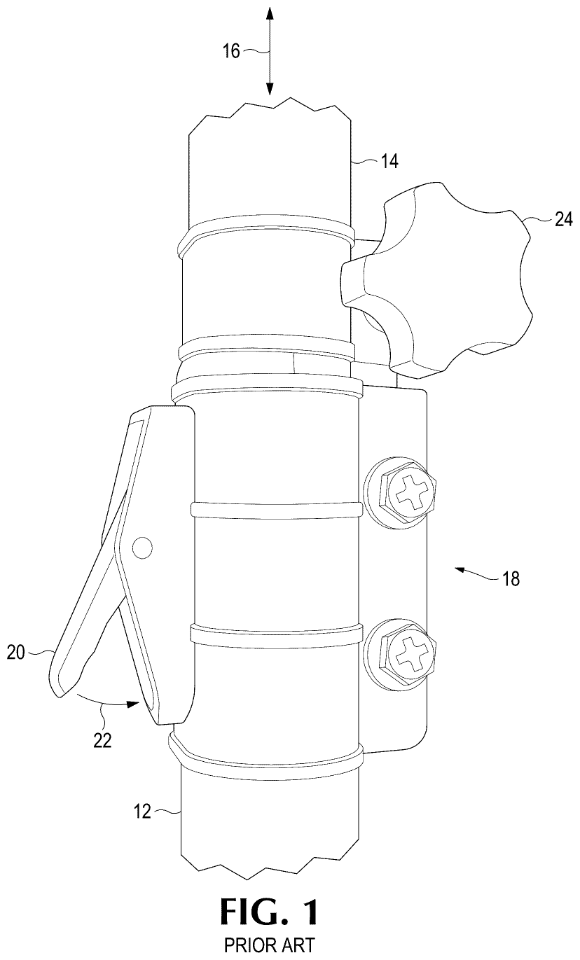

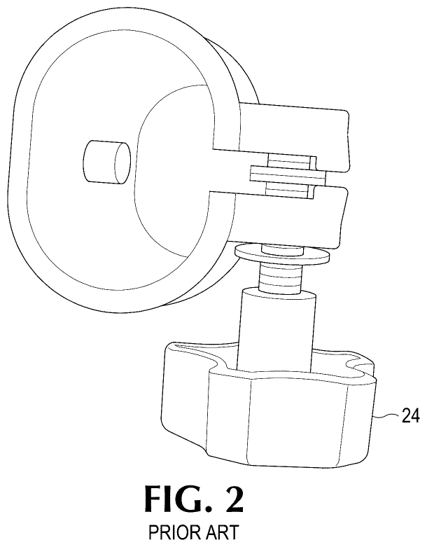

### DETAILED DESCRIPTION

The system according to a preferred embodiment of the present disclosure comprises a mechanism for allowing segments of an extensible pole to be easily extended, retracted and locked in position for use.

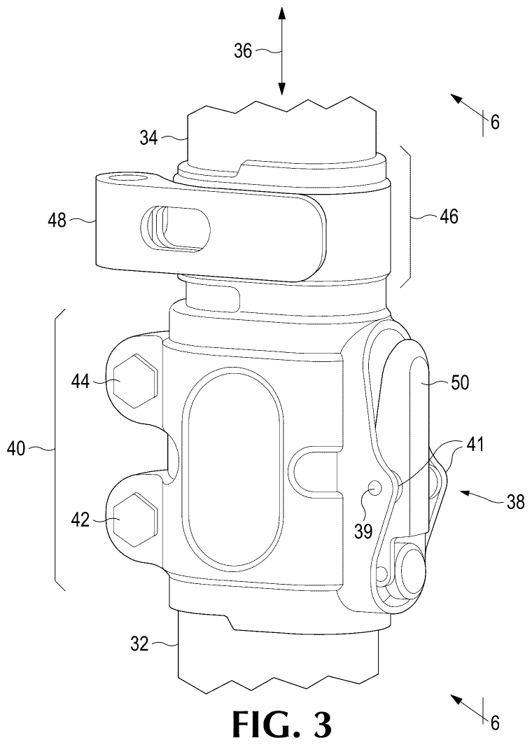

FIG. 3 is a perspective view of 2 segments of a telescopic pole coupling mechanism in accordance with the disclosure, a first pole segment 32 receives a second pole segment 34 in the interior thereof, engaged to allow translational movement of the 2 pole segments relative to each other in the direction of arrow 36, allowing extension and retraction of the overall pole length. Pole 34 is slightly lesser diameter than pole 32, which allows movement between the 2 poles. This provides for telescopic movement of the pole sections.

Mounted at the end of pole 32, is lock/clamp coupling mechanism 38. The lower portion 40 of mechanism 38 is securely fixed to the upper end of pole 32, secured by bolts is securely attached to the upper end of pole 32, secured by bolts 42, 44, while an upper portion 46 of the coupler extends beyond the top of pole 32, receiving pole 34 therein in a sliding arrangement that allows pole 34 to move in the directions of arrow 36. Portion has a cam over locking mechanism 48 to clamp the pole 34 within the upper portion 46 when the cam over locking mechanism is in a closed position (as in FIG. 3).

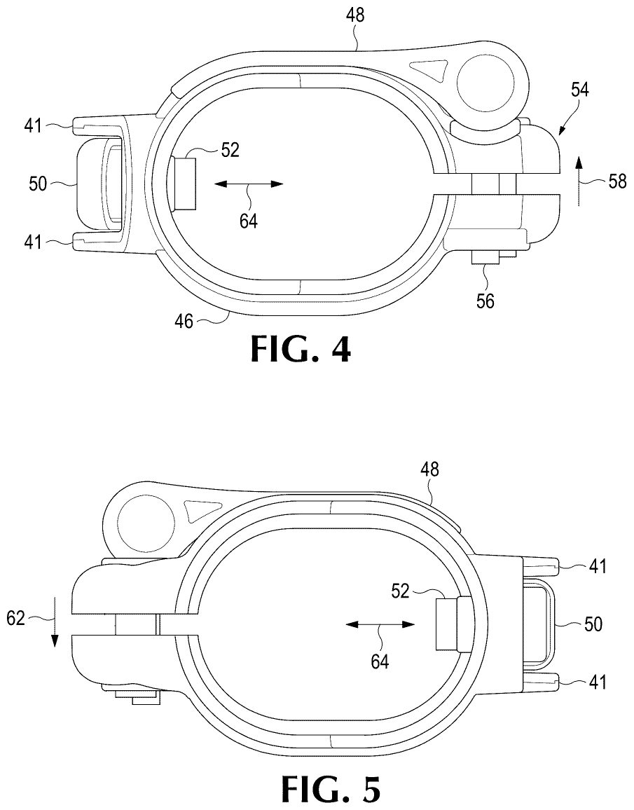

The lower portion 40 also carries a pin actuator 50 that is operable to extend or retract a pin 52 (visible in FIG. 4) through the holes in the pole segments 32 and 34, thereby locking the 2 pole segments when the pin is inserted, preventing movement of the 2 pole segments in the directions of arrow 36, or, when the pin is retracted, allowing the pole 34 to slid into and out of pole 32 along arrow 36. The pin actuator is mounted by a pin 39 that passes through the approximate center of the actuator, the pin supported on the by left and right tab members 41 that raise outwardly on the body of the mechanism 38, allowing teeter/totter motion of the actuator by depressing the actuator towards the center of the mechanism.

Referring to FIG. 4 and FIG. 5, a top view and bottom view of the coupler mechanism, the upper portion of the mechanism has a split side 54 and compression locking mechanism. The cam over locking mechanism 48 works with a shaft 56 to pull the split portions together in the direction of arrow 58, thereby clamping pole 34, preventing pole 34 from sliding into or out of pole 32 even if the locking pin is not engaged. This provides a compression style lock.

The bolts 42, 44 also operate to pull the split side portions of the portion 40 together in the direction of arrow 62 when tightened, clamping portion 40 to the lower pole 32. In FIGS. 4 and 5, the pin 52 may be observed, the pin extending into or out of the interior of the poles in the directions of arrow 64 by operation of the mechanism 50.

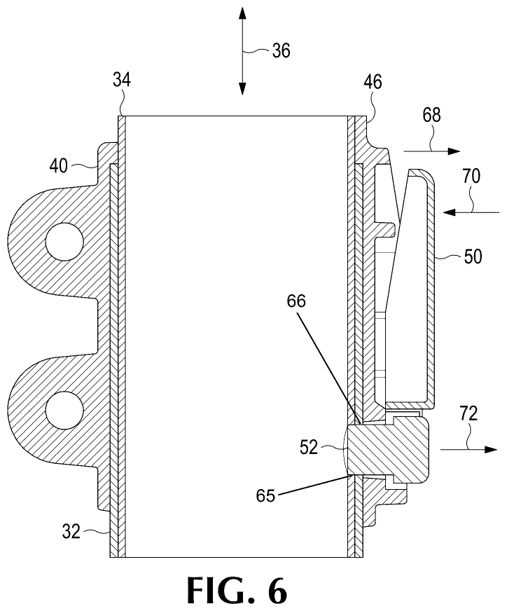

Referring to FIG. 6, a sectional view taken along line 6-6 of FIG. 3., operation of the pin 52 may be better understood. In the configuration shown in FIG. 6, pin 52 passes through both hole 66 in pole 32 and hole 65 in pole 34, acting to lock the 2 pole segments in position, preventing them from moving relative to each other in the directions of arrow 36. Mechanism 50 is spring biased in the direction of arrow 68 to keep pin 52 engaged with the holes in the poles in absence of user intervention. When the user wishes the poles to be moved relative to one another, the cam over locking mechanism 48 is opened and the mechanism 50 is depressed in the direction of arrow 70, which by lever action retracts the pin in the direction of arrow 72, freeing the 2 poles to move relative to one another.

It may be observed in FIGS. 4 and 5, that the tab members 41 extend outwardly from the mechanism to a height greater than the outward extent of the actuator 50, so the actuator has a lower profile than the outermost extent of the mechanism.

While a single segment of 2 poles is illustrated, multiple pole segments can be employed, to provide a wide range of extensibility.

The top pole carries a tool mount at the distal end thereof, allowing a tool such as a saw, shear or picking tool to be mounted thereon, for forestry, arborist or horticultural use.

The lowest base section pole at its bottom end has a cushioning cover thereon, to protect the pole bottom against damage should the user drop the pole. Also, a TPR (thermoplastic rubber) cover is incorporated to the base section pole to provide comfort, promote better control, handling and ergonomics.

In the illustrated version, the mechanism 50 is oriented upwardly towards the upper pole segment, but another embodiment has the mechanism 50 flipped vertically so that the actuation end lever is oriented downwardly rather than upwardly.

The actuator and mechanism 50 and 48 are designed with a low profile as noted above with regard to actuator 50, so as to minimize the likelihood of tangling with or engaging with branches or the like when in use. As may be observed in FIG. 4 and FIG. 5, the profile of the most external portions mechanism 48 is substantially the same as or just slightly extending beyond the outer profile of the pole coupling mechanism 38 when the mechanism 48 is in the closed position which will minimize interference with branches or the like.

Actuator 50 and the outer edge of pin 52 are positioned within the outer perimeter extent of the device when in the locked/use position, further minimizing the likelihood of interference with branches or the like.

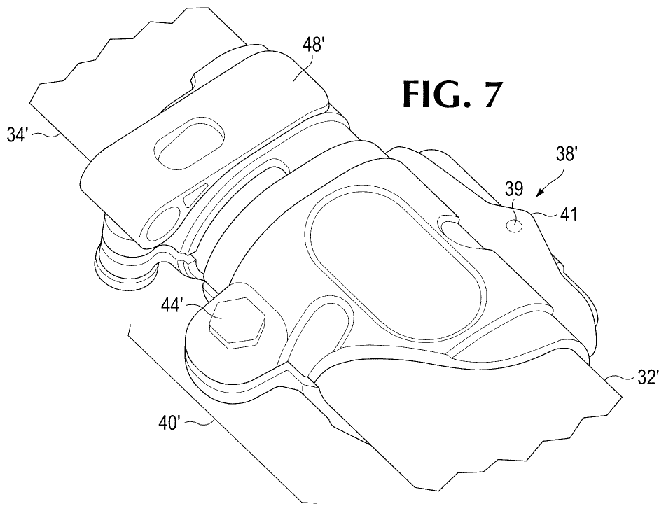

FIG. 7 is a perspective view of an alternative configuration pole segment coupler that presents a different aesthetic appearance. In this configuration, the lower portion 40′ of mechanism 38′ employs a single bolt 44′ omitting a bolt corresponding to bolt 42, and has a curved transition, giving a different aesthetic appearance from the mechanism 38. This configuration also can require less material to manufacture.

In a preferred embodiment, the body of the coupler mechanism and cam over locking mechanism are made from nylon-fiberglass, the pole sections are aluminum 6063-T6, but could be 6061-T6, the pin metal such as stainless steel, the pin actuator is metal with hard chrome plating. The bottom end cushioning cover is natural rubber and as previously mentioned, base section grip comprises a TPR cover over the aluminum pole.

While a preferred embodiment of the technology has been shown and described, it will be apparent to those skilled in the art that many changes and modifications may be made without departing from the broader aspects. The appended claims are therefore intended to cover all such changes and modifications as fall within the true spirit and scope of the technology.

What is claimed is:

1. A telescopic pole coupling mechanism, comprising:
a lock/clamp coupling mechanism adapted to be securely fixed to an end of a first pole, and including a receiving sleeve for receiving a second pole therein in sliding engagement;
a cam over locking mechanism for locking the second pole against sliding in relation to the first pole.

2. The telescopic pole coupling mechanism according to claim 1, wherein said lock/clamp coupling mechanism further comprises an upper portion that extends beyond an end of the first pole to extend along a portion of the second pole.

3. The telescopic pole coupling mechanism according to claim 2 wherein said cam over locking mechanism is positioned in the upper portion.

4. The telescopic pole coupling mechanism according to claim 3 wherein said upper portion comprises first and second split portions and said cam over locking mechanism locks said first and second poles against sliding by pulling the first and second split portions together.

5. The telescopic pole coupling mechanism according to claim 1 further comprising a pin actuator that is operable to extend or retract a pin into engagement between the first pole and the second pole.

6. The telescopic pole coupling mechanism according to claim 5, wherein an activation member for said the engagement of the pin with said first and second poles comprises extended through respective holes in said poles.

7. The telescopic pole coupling mechanism according to claim 5 wherein said pin actuator has a low external profile.

8. The telescopic pole coupling mechanism according to claim 1, wherein said cam over locking mechanism has a low external profile.

9. A coupler mechanism for telescopic pole segments, comprising:
a first pole engaging section for securely mounting to a first pole;
a second pole engaging section for sliding engagement with a second pole;
a first lock mechanism comprising an engagement pin locking the first and second poles against translational movement relative to one another;
a second lock mechanism for clamping the second pole engagement section,
wherein actuation components of the first lock mechanism and the second lock mechanism have low profiles to reduce unintended engagement with branches when in use.

10. The coupler mechanism for telescopic pole segments according to claim 9, wherein said second lock mechanism comprises a cam over locking mechanism for locking the second pole against sliding in relation to the first pole.

11. The coupler mechanism for telescopic pole segments according to claim 10, wherein said cam over locking mechanism is positioned in the second pole engaging section.

12. The coupler mechanism for telescopic pole segments according to claim 9, wherein first locking mechanism is positioned in the first pole engaging section.

13. A telescopic pole segment coupler, comprising:
a first pole engaging section for securely mounting to a first pole;
a second pole engaging section for sliding engagement with a second pole, said second pole sized for translational movement into and out of an interior of the first pole;
a first lock mechanism comprising an engagement pin for locking the first and second poles against translational movement relative to one another;
a second lock mechanism for clamping the second pole engagement section,
wherein actuation components of the first lock mechanism and the second lock mechanism have low profiles to reduce unintended engagement with branches when in use.
